(19) United States
(12) Patent Application Publication
(10) Pub. No.: US 2022/0011753 A1
(43) Pub. Date: Jan. 13, 2022

(54) GENERATING AND DISTRIBUTING CONFIGURATION DATA STRUCTURES FOR CONTROL SYSTEMS

(71) Applicant: WAGO Verwaltungsgesellschaft mbH, Minden (DE)

(72) Inventor: Thomas GAUS, Fluorn-Winzeln (DE)

(73) Assignee: WAGO Verwaltungsgesellschaft mbH, Minden (DE)

(21) Appl. No.: 17/487,938

(22) Filed: Sep. 28, 2021

Related U.S. Application Data
(63) Continuation of application No. PCT/EP2020/057968, filed on Mar. 23, 2020.

(30) Foreign Application Priority Data
Apr. 1, 2019 (DE) 10 2019 204 585.5

(51) Int. Cl. G05B 19/418; G06F 9/50

(52) U.S. Cl. CPC G05B 19/4185; G05B 19/41845; G05B 2219/25057; G05B 2219/23193; G05B 2219/25274; G06F 9/5072

(57) ABSTRACT

A configuration data structure for control systems in an automation system and to a method, a cloud computing unit, a control system, and a computer program for generating the configuration data structure. The configuration data structure comprises a cloud component, which provides at least one cloud function that can be carried out on the cloud computing unit, and a system component, which provides at least one system function that can be carried out on the control systems.

This nonprovisional application is a continuation of International Application No. PCT/EP2020/057968, which was filed on Mar. 23, 2020, and which claims priority to German Patent Application No. 10 2019 204 585.5, which was filed in Germany on Apr. 1, 2019, and which are both herein incorporated by reference.

### BACKGROUND OF THE INVENTION

### Field of the Invention

The present invention relates to a configuration data structure for control systems in an automation system and to a method, a cloud computing unit, a control system, and a computer program for generating the configuration data structure.

### Description of the Background Art

Automation technology is used in particular to control industrial systems, buildings, and means of transport. In the context of automation technology, the connection of control systems (e.g., WAGO controllers) to a cloud infrastructure (e.g., WAGO Cloud, Microsoft Azure, Amazon Web Services, IBM Cloud, SAP Cloud, etc.) is becoming increasingly important. Such control systems are used in particular in the field of industrial automation or in connection with the automation of buildings.

The connection of control systems to a cloud infrastructure is currently a process that must be executed manually by specialists. The process is error-prone and requires a rather long time. Typically, quite a number of system functions must be set up for each control system. Missing or incorrect settings can lead, among other things, to incorrect or absent alarms, etc.

Further, the required cloud functions must be set up on the side of the connected cloud infrastructure. These include, for example, suitable user interfaces in the form of so-called dashboards.

However, changes to the configuration are occasionally necessary not only for the connection but also during operation; these changes are associated with a corresponding effort in the case of a large number of control systems.

In building automation in particular, a large number of comparable control systems with similar tasks which also require the same or similar configurations are often used. In this case, the use of templates for configuring similar control systems can be advantageous in order to save configuration effort.

The use of templates for cloud-based resources is known from U.S. Pat. No. 8,775,626 B2. The templates are used to store cloud configuration information in a central location and support the automated deployment of resources in a cloud system.

Cloud templates in an industrial context are known from U.S. Pat. No. 9,128,472 B2. The patent describes both the structure of the cloud templates themselves and the structure of the overall system. U.S. Pat. No. 9,568,909 B2 builds on U.S. Pat. No. 9,128,472 B2 and describes so-called “cloud dashboard templates.”

Among other things, a method for the automatic configuration of functional units of an automation system is known from EP 3,349,081 A1, which corresponds to US 2019/0356503. This is achieved in that agents assigned to an automation solution detect their environment (locally reachable devices, data sources, etc.) and generate a corresponding device list. This is then compared with a system configuration located in the cloud. If there is a match, the configuration data are then transmitted to the respective agent.

The article “How to Use the Cloud to Store and Distribute Manufacturing Data” (18 Sep. 2017, International Society of Automation) describes advantages in the context of “prebuilt templates” which simplify the deployment of new cloud resources (e.g., storage, virtual servers).

### SUMMARY OF THE INVENTION

It is therefore an object of the present invention to develop further the concepts for cloud-based management of control systems in an automation system, in particular in order to make the configuration of control systems simpler, faster, more secure, and/or more efficient.

The object is achieved with a configuration data structure and with a method, a cloud system, a control system, and a computer program for generating the configuration data structure.

In a first aspect of the present invention, a method for generating a first configuration data structure for a first control system of an automation system is provided, wherein the first control system can also be referred to as a first subscriber of the automation system. The configuration data structure can be generated both by a cloud computing unit of a cloud system and also by a second control system, wherein the cloud computing unit and the second control system can also be referred to as a second subscriber of the automation system. Further, the first configuration data structure comprises a cloud component and a system component. The cloud component provides at least one cloud function which can be carried out on the cloud computing unit; and the system component provides at least one system function which can be carried out on the first control system.

The configuration data structure can be particularly suitable for a specific application, for example, for a control system in the context of tasks in office buildings, in discount stores, in water treatment, in industrial automation, etc.

Advantageously, the cloud component can comprise further display names, data formatting, units, threshold values, authorization information, predefined visualizations (associated with data points), statistical evaluations, a control system status, meta information, alarm configurations, configurations of aggregate formations, definitions of additional calculations, user authorizations, algorithms for data analysis, data export definitions, VPN configurations, backup/restore information, diagnostic information, and/or definitions of rules.

The system component advantageously comprises further information about a data collection frequency, information about a data transmission frequency, information about a data transmission type, information about a type of data sent, configuration of a PLC program, visualization components, firmware versions, backup and diagnostic settings, settings as to whether data should be sent compressed or uncompressed, settings about possible preaggregations or filtering of data, settings about scaling and/or conversion of values, and/or information about connected sensors/actuators.

In contrast to the state of the art, as mentioned above, the configuration data structure according to one aspect of the invention is constructed in two parts. This division into two parts, namely into a cloud component and a system component, and the associated modularization have a number of technical advantages:

For example, a cloud function of the cloud component can provide a dashboard in order to display information from the control system, so that a user (for example, a system administrator of the automation system) can monitor and control all connected control systems on the cloud side. The cloud function with the dashboard of different control systems can be built up with a uniform data structure, so that a uniform user interface can be set up on the cloud side in order to display information from different control systems.

To configure a control system, a configuration data structure is sent to the control system. The control system can, on the one hand, take over the system component and, on the other hand, retain and continue to use the cloud component in order to generate a new configuration data structure. The newly generated configuration data structure can be used, for example, to configure a similar control system, wherein the newly generated configuration data structure can be sent directly to the similar control system or via the cloud system to the similar control system.

This use is particularly advantageous when, e.g., a control system is initially configured by receiving a configuration data structure and has later adopted new settings during operation (e.g., by a direct change to the control system by a user). The control system can then generate a new system component based on the new configuration and send it to the cloud system, and the cloud system can pack the system component together with a cloud component in order to generate a new configuration data structure. Additionally or alternatively, the control system can use the cloud component of a previously obtained configuration data structure and pack a new system component together with the cloud component and generate a new configuration data structure itself. The new configuration data structure can then be used to configure a similar control system. As a result, a new configuration data structure does not need to be generated for each control system.

In a further aspect, control systems can also comprise gateway functionalities in addition to their actual control tasks. For example, in this case the second control system can obtain the first configuration data structure from the cloud system and then forward it to the first control system. Thus, each control system does not need to obtain a configuration data structure from the cloud system, but also alternatively obtain it from another control system, e.g., if the cloud system is burdened or the cloud system cannot provide a suitable configuration data structure.

In a further aspect, a user unit is connected to the cloud computing unit of the cloud system, via which the cloud system receives user inputs from a user and generates the first configuration data structure based thereon. The user inputs can be used by the cloud computing unit in order to modify the cloud component or the system component of the first configuration data structure before the first configuration data structure is distributed.

Further, a database can also be integrated into the automation system, so that the cloud computing unit uses entries from the database to modify a configuration data structure. The database can be formed in the cloud system, a control system, or in another memory.

As described above, both the generation and the distribution of configuration data structures can be designed very flexibly. With the use of the present invention, a redundant generation of configuration data of similar control systems is avoided. Further, the flexibility and security of the entire automation system increase, because a control system can obtain a configuration data structure not only from the cloud system but also from another control system.

A control system can carry out a system function while the control system is in operation. During the execution of the system function, process data can be generated and forwarded to the cloud system in order to be evaluated by the cloud computing unit. After the evaluation, the cloud computing unit generates input data and sends them as a response to the control system.

Further, the distribution of a configuration data structure to a control system can be automated, e.g., by means of a unique identifier for each control system and an association between the unique identifier and a suitable configuration data structure. For example, when the first control system is connected to the automation system, the control system can send a unique identifier to the cloud system, the second control system, or to some other control system that is connected to the first control system via the network. The cloud system, the second control system, or the other control system then checks whether there is a configuration data structure in its own memory that corresponds to the unique identifier of the first control system. If a configuration data structure corresponding to the unique identifier of the first control system is available, this configuration data structure is sent to the first control system.

The present invention also provides a method for configuring a first control system in an automation system. The first control system receives a first configuration data structure from a cloud system or a second control system. Further, the configuration data structure comprises a cloud component and a system component as described above.

The system component of the first configuration data structure can be taken over by the first control system, as a result of which the first control system is configured. Further, the first control system can store the cloud component of the first configuration data structure in a memory in order to use the cloud component later to generate a new (a second) configuration data structure.

In a further aspect, the present invention provides a cloud computing unit for generating and distributing configuration data structures. The present invention also provides a control system, which may be the first or second control system described above. In addition, the present invention also provides a computer program for executing one of the methods described above.

The present invention relates further to a configuration data structure which is configured for use in the cloud system described above and in the automation system described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic arrangement with a user unit, a cloud system, and three control systems of an automation system according to an exemplary embodiment of the present invention;

FIG. 2 shows a schematic structure of a configuration data structure according to an exemplary embodiment of the present invention; and

FIG. 3 shows an exemplary configuration data structure for a control system in the field of building automation according to an exemplary embodiment of the present invention.

### DETAILED DESCRIPTION

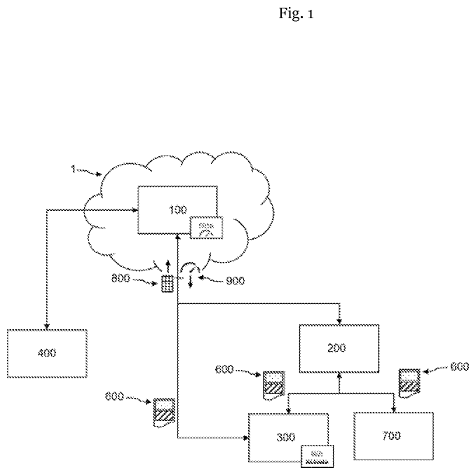

FIG. 1 shows a schematic arrangement with a user unit 400, a cloud system 1, and three control systems 200, 300, and 700 of an automation system according to an exemplary embodiment of the present invention. Control systems 200, 300, and 700 can also be referred to as control/data collection units because, in addition to control functions, they also have data collection functions. Cloud system 1 comprises a cloud computing unit 100. Furthermore, cloud system 1 can have a storage/data management unit, a display unit, a user management unit, and/or a device management unit, etc. (not shown).

Cloud system 1 is located, for example, in an internal cloud infrastructure and/or in an external cloud infrastructure.

Cloud system 1 is connected to a user unit 400 via a network. User unit 400 can be, for example, a PC or a mobile terminal with a web browser and/or a specific application that enables access to cloud system 1. The network can be both wired and/or wireless.

Further, the network connects control systems 200, 300, and 700 to cloud system 1. In this example, three control systems of the automation system are shown in order to explain the corresponding functionalities. It is understood, however, that the number of control systems in an automation system can be as desired; more precisely stated, the number can be between 1 and N, where N is an integer greater than 1. In addition, control system 200 is also connected to control systems 300 and 700 via the network.

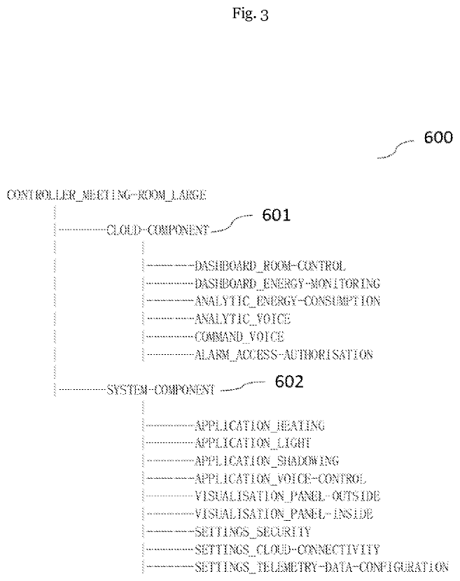

Further, FIG. 1 shows that cloud computing unit 100 can send a configuration data structure 600 (hereinafter also referred to as a cloud template) to control system 200 or 300. Control system 200 can also send a configuration data structure 600 to control system 300 or 700, and control system 200 or 300 can in turn send a configuration data structure 600 to cloud system 1. With the present structure, control system 200 can obtain a configuration data structure 600 from cloud computing unit 100 and send it further to control system 300 or 700; i.e., control system 200 in this case functions as a gateway between cloud computing unit 100 and other control systems. In addition, control system 200, 300, or 700 sends process data 800 to cloud computing unit 100, wherein process data 800 are evaluated by cloud computing unit 100. Cloud computing unit 100 then sends input data 900 to control system 200, 300, or 700 in response to the evaluation of process data 800. Further, input data 900 can also be generated, e.g., by clicking on a button in a dashboard, etc. These various scenarios are described in more detail below in FIG. 3 with a specific example of configuration data structure 600, after the structure of configuration data structure 600 is explained in more detail.

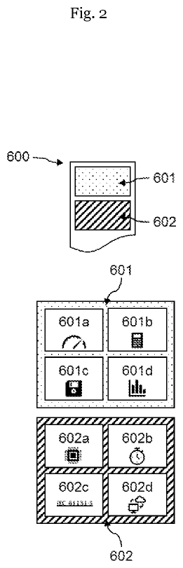

As shown in FIG. 2, a configuration data structure 600 (cloud template) according to one embodiment comprises a cloud component 601 and a system component 602. This modular structure of the cloud template is preferred in some embodiments, but it should be noted that aspects of the present invention can also function with differently structured cloud templates.

Cloud component 601 has at least one cloud function 601a, 601b, 601c, and/or 601d which can be carried out on cloud system 1.

Cloud function 601a contains a pointer element, e.g., for displaying a total power consumption of a building for use within a dashboard.

Configurations for forming an aggregate (e.g., a calculation formula for generating a sum of the total power consumption of a building) can be edited by cloud function 601b.

Configurations with respect to storage of the process data (e.g., relating to storage location and storage duration in the cloud) can be edited by cloud function 601c.

Cloud function 601d provides a bar chart (e.g., to display the course of the room temperature) for use within a dashboard.

Further, cloud component 601 includes, in particular, settings, configurations, contents, etc., which are required for the display of data with respect to the control systems on the cloud side. These include in particular configuration data (display names, data formatting, units, threshold values), authorizations, predefined visualizations connected to data points (e.g., SVG widgets), statistical evaluations (e.g., comparisons of values over time), device status, device meta information, alarm configurations, configurations of the aggregate formations, definitions of additional calculations, user authorizations, algorithms for data analysis, additional attributes, data export definitions, VPN configurations, backup/restore information, diagnostic information, and rules (e.g., IFTTT (“if this then that”) rules).

System component 602 has at least one system function 602a, 602b, 602c, and/or 602d which can be carried out on a control system 200, 300, or 700.

System function 602a provides information regarding a specific firmware version.

Configurations relating to the data collection frequency and the data transmission frequency can be edited by system function 602b.

System function 602c is a PLC program, e.g., for controlling a meeting room.

System function 602d provides connection information to the cloud (e.g., formed of an activation key and a device identifier).

Further, system component 602 comprises in particular settings and configurations which are required directly in the control systems. These include in particular information about the data collection frequency, the data transmission frequency, and the type of transmission (e.g., telemetry (=cyclical), event (=alarm), value change). Information about the type of data sent (e.g., raw data, aggregates, or about the format and the associated data units) can also be components. PLC programs, e.g., with defined functions such as “close fire doors,” “raise sunscreens at wind force 1,” visualization components, and firmware versions can also be contained in system component 602, as well as backup and diagnostic settings. Settings as to whether the data are to be sent compressed or uncompressed, or settings with regard to possible preaggregations or filtering of data, scaling and conversion of values, etc., can also be contained in system component 602. Further, changes can be made to the PLC program by means of system component 602, e.g., what data should be sent or the configuration of the PLC program. Information about connected sensors/actuators can also be components.

Cloud computing unit 100 can generate, change, copy, and/or save a configuration data structure 600. Through user input via user unit 400, cloud computing unit 100 can add a system function 602a, 602b, 602c, or 602d in a system component 602 or edit/change an existing system function 602a, 602b, 602c, or 602d in the system component, in order to create/generate a new configuration data structure (600), or to edit/change an existing configuration data structure (600).

Further, through user input via user unit 400, cloud computing unit 100 can add a cloud function 601a, 601b, 601c, or 601d in a cloud component 601 or edit/change an existing cloud function 601a, 601b, 601c, or 601d in cloud component 601, in order to create/generate a new configuration data structure 600, or to edit/change an existing configuration data structure 600.

In addition, a database can be integrated with cloud computing unit 100 and cloud computing unit 100 can use entries in the database in order to add/change a system function 602a, 602b, 602c, or 602d in a system component 602 or to add/change a cloud function 601a, 601b, 601c, or 601d in a cloud component 601. The database can be formed in the cloud, in a control system, or in any other memory.

Control system 200 further functions as a gateway and forwards configuration data structure 600 from cloud computing unit 100 to control system 300 and/or 700. Otherwise it is also possible that control system 200 generates a configuration data structure 600 by itself and this is sent to control system 300 and/or 700.

In a further example (not shown in FIG. 1), control system 200 is already configured and control system 200 generates a system component 602 based on its own configuration. This system component 602, which can be edited by cloud computing unit 100, is sent further to cloud system 1 in order to generate a new configuration data structure 600, wherein a user can change parameters of system component 602 via user unit 400 before the new configuration data structure 600 is generated.

In yet another example, control system 300 is configured and control system 300 generates a new configuration data structure 600 based on its own configuration and on a cloud component 601 of a previously obtained configuration data structure 600. This new configuration data structure 600, which can be stored, e.g., directly in a memory of cloud system 1 or can be distributed further to any control system, is then sent further to cloud computing unit 100. It is also possible for a user to change via user unit 400 the parameters of configuration data structure 600 sent by control system 300 before configuration data structure 600 is stored in the memory of cloud system 1 or distributed to any control system.

A configuration data structure 600 can be distributed from cloud computing unit 100 by means of instructions entered by a user via user unit 400.

Further, an automatic transmission of configuration data structures 600 without instructions via user unit 400 is also possible. The automatic transmission of configuration data structures 600 can take place both independently between the individual control systems as soon as an identical or similar control system is connected to the network or also via cloud computing unit 100, however. Here, the newly connected control system sends a unique identifier to cloud computing unit 100. In cloud computing unit 100, the unique identifier is compared with the stored configuration data structures. If they match, the matching configuration data structure 600 is automatically assigned to the corresponding control system. Otherwise, the newly connected control system can send a unique identifier, e.g., to control system 200. In control system 200, the unique identifier is then compared with the stored configuration data structures.

Configuration data structure 600 can be particularly suitable for a specific application, for example, for a control system in the context of tasks in office buildings, in discount stores, in water treatment, in industrial automation, etc. A specific application example is described below with reference to FIG. 3.

FIG. 3 shows an exemplary configuration data structure 600 for a control system 200, 300, or 700 in connection with a cloud system 1. According to the invention, configuration data structure 600 contains a cloud component 601 and a system component 602. In this example, configuration data structure 600 is provided for a control system 200, 300, or 700 in the field of building automation. More precisely, it concerns a control system 200, 300, or 700, which enables intelligent and efficient use of a meeting room.

A specific application example is described below.

Cloud component 601 contains, among other things, cloud functions which are designed for operating and monitoring a control system. The cloud functions can be carried out on cloud computing unit 100. As shown in FIG. 3, cloud component 601 has the following functions:

DASHBOARD_ROOM-CONTROL, which enables, e.g., remote operation of heating in the meeting room via a graphical dashboard, wherein the graphical dashboard can be accessed via user unit 400 and, in addition to temperature control, also provides insight into the actual current temperature;

DASHBOARD_ENERGY-MONITORING, which provides another graphical dashboard to enable access to energy monitoring in the context of the meeting room;

ANALYTIC_ENERGY-CONSUMPTION, which provides a basis for the cloud function DASHBOARD_ENERGY-MONITORING, which obtains process data 800 from control system 200, 300, or 700, analyzes it, and can thus provide information about past and expected energy consumptions;

ANALYTIC_VOICE, which is a cloud function for analyzing voice commands forwarded to cloud computing unit 100 by a system function in the form of process data 800;

COMMAND_VOICE, which enables transmission of a corresponding control command in the form of input data 900 back to control system 200, 300, or 700 after the voice commands have been evaluated by the cloud function ANALYTIC_VOICE;

ALARM_ACCESS_AUTHORISATION, which enables automatic alerting in the event of unauthorized access to the meeting room, wherein in this case the cloud function ALARM_ACCESS_AUTHORISATION enables defined persons to be notified by email, phone call, SMS, etc.

System component 602 contains, among other things, system functions which are carried out on a control system. As shown in FIG. 3, system component 602 has the following system functions:

APPLICATION_HEATING, which enables control of the heating;

APPLICATION_LIGHT, which enables control of the lighting;

APPLICATION_SHADOWING, which enables control of the sunscreens;

APPLICATION_VOICE-CONTROL, which enables input of voice commands and their forwarding in the form of process data 800 to cloud computing unit 100;

VISUALISATION_PANEL-OUTSIDE for the visualization of room functions on screens in front of a meeting room;

VISUALISATION_PANEL-INSIDE for the visualization of room functions on screens inside the meeting room;

SETTINGS_SECURITY, which enables security settings such as firewall, access rights, etc., for a control system;

SETTINGS_CLOUD-CONNECTIVITY, which enables settings regarding the communication between the control system and cloud system 1; and

SETTINGS_TELEMETRY-DATA-CONFIGURATION for writing data transmitted by the control system (e.g., with regard to data type, measured value unit).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method comprising:
generating a first configuration data structure for a first subscriber of an automation system, which is a first control system, carried out by a second subscriber which is a second control system or a cloud computing unit in a cloud system;
providing the first configuration data structure with a cloud component, which provides at least one cloud function which is carried out on the cloud computing unit; and
providing the first configuration data structure with a system component, which provides at least one system function which is carried out on the first control system.

2. The method according to claim 1, wherein the cloud component further comprises: display names, data formatting, units, threshold values, authorization information, predefined visualizations, statistical evaluations, a control system status, meta information, alarm configurations, configurations of aggregate formations, definitions of additional calculations, user authorizations, algorithms for data analysis, data export definitions, VPN configurations, backup/restore information, diagnostic information, and/or rules.

3. The method according to claim 1, wherein the system component further comprises: information about a data collection frequency, information about a data transmission frequency, information about a data transmission type, information about a type of data sent, configurations of a PLC program, visualization components, firmware versions, backup and diagnostic settings, settings as to whether data should be sent compressed or uncompressed, settings about possible preaggregations or filtering of data, settings about scaling and/or conversion of values, and/or information about connected sensors/actuators.

4. The method according to claim 1, further comprising: sending, by the cloud computing unit, the first configuration data structure to the first control system via the second control system, wherein the second control system acts as a gateway.

5. The method according to claim 1, further comprising: obtaining a system component by the cloud computing unit from the first control system or from the second control system, wherein the generation of the first configuration data structure for the first control system is based on the obtained system component.

6. The method according to claim 5, further comprising: before the first configuration data structure is sent, modifying, by the cloud computing unit, the cloud component or the system component of the first configuration data structure based on user inputs input by a user via a user unit and/or based on entries in a database.

7. The method according to claim 6, wherein the database is formed in the cloud system in the first or second control system or in another memory.

8. The method according to claim 1, further comprising: obtaining a second configuration data structure, generated by the first control system, by the cloud computing unit from the first control system.

9. The method according to claim 1, further comprising:
obtaining process data from the first or second control system by the cloud computing unit;
evaluating the process data; and
outputting input data to the first or second control system, which trigger at least one system function in the first or second control system.

10. The method according to claim 1, further comprising:
obtaining a unique identifier from the first control system by the second participant;
checking whether a configuration data structure corresponding to the identifier is present in a memory of the second subscriber; and
if a configuration data structure corresponding to the identifier is present in the memory, sending the corresponding configuration data structure to the first control system.

11. A method for configuring a first control system of an automation system, the method comprising:
receiving a first configuration data structure by a first subscriber of an automation system, which is a first control system, from a second subscriber which is a second control system or a cloud computing unit in a cloud system, wherein the first configuration data structure comprises:
a cloud component which provides at least one cloud function which is adapted to be carried out on the cloud computing unit; and
a system component which provides at least one system function which is adapted to be carried out on the first control system; and
taking over the system component of the first configuration data structure.

12. The method according to claim 11, further comprising: sending a unique identifier by the first control system to the second subscriber when the first control system is connected to the automation system.

13. The method according to claim 11, further comprising: storing the cloud component of the first configuration data structure in a memory of the first control system.

14. The method according to claim 11, further comprising:
generating a second configuration data structure based on an existing unique configuration and the cloud component from the first configuration data structure by the first control system; and
sending the generated second configuration data structure to the cloud computing unit.

15. The method according to claim 11, further comprising:
generating a system component, based on an existing unique configuration, by the first or second control system; and
sending the generated system component to the cloud computing unit,
wherein the generating of the first configuration data structure (600) is based on the system component.

16. The method according to claim 11, further comprising:
sending process data by the first or second control system to the cloud computing unit, wherein the process data are evaluated by the cloud computing unit; and
obtaining input data from the cloud computing unit after evaluating the process data, wherein the input data trigger at least one system function in the first or second control system.

17. A cloud computing unit configured to carry out the method according to claim 1.

18. A control system configured to carry out the method according to claim 1.

19. A computer program which has instructions for carrying out the method according to claim 1.

20. A configuration data structure configured for use in the cloud computing unit according to claim 17 and/or in a control system.
